(19) United States
(12) Patent Application Publication
(10) Pub. No.: US 2009/0132757 A1
(43) Pub. Date: May 21, 2009

(54) STORAGE SYSTEM FOR IMPROVING EFFICIENCY IN ACCESSING FLASH MEMORY AND METHOD FOR THE SAME

(75) Inventors: Jin-min Lin, Taipei City (TW); Feng-shu Lin, Sindian City (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/211,656

(22) Filed: Sep. 16, 2008

(30) Foreign Application Priority Data
Nov. 15, 2007 (TW) 096143279

(51) Int. Cl. G06F 12/02; G06F 12/08

(52) U.S. Cl. 711/103; 711/118; 711/E12.008; 711/E12.017; 711/E12.019

(57) ABSTRACT

A storage system for improving efficiency in accessing flash memory and method for the same are disclosed. The present invention provides a cache unit for temporarily storing data prior to writing in the flash memory or reading from the flash memory. In reading process, after data stored in a flash memory is accessed by a host, the cache unit holds the data. Upon subsequent read requests to read the same data, the data is cached accordingly, thereby shortening a preparation time for reading the data from the flash memory. In writing process, a host requests write a series of requests to write data into the flash memory, the data is gathered and is stored in the cache unit until the cache unit is full. A cluster of data in the cache unit is accordingly written into the flash memory, so that a preparation time for writing the data into the flash memory is also shortened.

### BACKGROUND OF THE INVENTION

1. Field of the Invention

The present invention relates to a storage system for accessing a flash memory and related method, and more particularly, to a storage system and related method capable of facilitating access efficiency to the flash memory, thereof.

2. Description of the Related Art

Flash Memory, a non-volatile memory, may keep the previously written stored data upon shutdown. In contrast to other storage media, e.g. hard disk, soft disk, magnetic tape and so on, the flash memory has advantages of small volume, light weight, vibration-proof, low power consumption, and no mechanical movement delay in data access, therefore, are for wide use as storage media in consumer electronic devices, embedded systems, or portable computers.

There are two kinds of flash memory: one is an NOR flash memory and the other is an NAND flash memory. An NOR flash memory is characteristically of low driving voltage, fast access speed, and high stability, and are widely applied in portable electrical devices and communication devices such as Personal Computers (PC), mobile phones, personal digital assistances (PDA), and set-top boxes (STB). An NAND flash memory is specifically designed as data storage media, for example, a Secure Digital (SD) memory card, a Compact Flash (CF) card, a memory Stick (MS) card. Upon writing, erasing and reading, charges move across a floating gate relying on charge coupling which determines a threshold voltage of a transistor under the floating gate. In other words, in response to an injection of electrons into the floating gate, the logical status of the floating gate turns from 1 to 0; on the contrary, in response to a move electrons away from the floating gate, the logical status of the floating gate turns from 0 to 1.

Please refer to FIG. 1 showing a structure of conventional NAND flash memory, the NAND flash memory 100 contains a plurality of blocks 12, each block 12 having a plurality of pages 14 and each page 14 dividing into a data area 141 and a spare area 142. The data area 141 may have 512 bytes used for storing data. The spare area 142 is used for storing error correction code (ECC). However, the flash memory fails to change data update-in-place, that is, prior to writing data into a non-blank page 14, erasing a block including the non-blank page 12 is required. In general, erasing a block take as much time as 10-20 times greater as writing into a page. If the size of written data is less than the corresponding block, original data in the other pages of the corresponding block have to be moved to the other free block, and then the written data should be written into the assigned block.

Furthermore, flash memory block may fail to access when in excess of one million times of erasures before the block is considered to be worn out. This is because the number of erasure times for a block is close to one million, charge within the floating gate may be insufficient due to current leakage of realized capacitor, thereby resulting in data loss of the flash memory cell, and even a failure of access to the flash memory. In other words, if erased over a limited times, a block may be unable to be accessed.

Therefore, a use of system of managing an access to the flash memory is very essential. Traditionally, the present file systems for managing access to the flash memory include Microsoft FFS, JFFS2, YAFFS and so on. These specific file systems have more efficiency in access the flash memory, yet only incorporate with storage media using the flash memory. The other way is to employ a Flash Translation Layer (FTL), which simulates the flash memory as a hard disk. In doing so, the upper layer of the FTL may uses a normal file system, such as FAT32 or EXT3, to write/read sectors at the lower layer to access to the flash memory by means of FTL. FTL creates a logical-physical address table which records information relating to the logical block addresses (LBA) mapping to the physical block addresses (PBA). Please refer to FIG. 2 which shows an example of data translation between logical addresses and physical addresses. Assume that each block has a number of n pages. When requesting to read data in LBA 1, the upper layer file system may translate LBA 1 as PBA B1-P1 via the logical-physical address table 16, and then return data in PBA B1-P1. When requesting to update LBA 3, the upper layer file system may, for example, firstly, remove data in PBA B0-P0 to PBA B0-P2 (belonging to Block 0) to PBA B2-P0 to PBA B2-P2 (belonging to Block 2); secondly, update new data into PBA B2-P3 (belonging to Block 2); thirdly, remove data in PBA B0-P4 to PBA B0-Pn-1 (belonging to Block 0) to PBA B2-P4 to PBA B2-Pn-1 (belonging to Block 2); fourthly, label the Block 0 as unusable, and finally modify information of LBA 3 mapping to PBA B2-P3 in the logical-physical address table 16. Once the subsequent read request for LBA 3 is received, PBA B2-P3 is accessible.

Despite the use of FTL may simplify management of access to flash memory and choose the upper file system, longer access time period and greater memory occupation are required on account of translations of all requests by means of FTL. For instance, provided that a number of ten consecutive requests, each of writing 2K bytes, are to be written into a block, the block is duplicated repeatedly by 10 times. That wastes much time.

Moreover, when the host intends to read a 2K bytes file distributed into blocks of the flash memory, the entire data is collected from different blocks and then return to the host; afterwards, the flash memory send a status information to the host after the data transmission is completed. During read procedure, a prepared time period caused by the FTL configuration, i.e., a sum of which the host sends the read request to the flash memory, and which the flash memory sends the status information to the host, does not proportionally increase as read data size, but the data transmission does. When the host sends a number of ten consecutive read requests, each of which is for reading 2K bytes, to read 20K bytes data from the flash memory, each read request corresponds to a read procedure, as extends more prepared time period. If the 20K bytes data corresponding to ten read requests may be read in one time, the entire prepared time period is accordingly shortened.

### SUMMARY OF THE INVENTION

It is therefore an object of the present invention to provide a storage system and related method capable of facilitating access efficiency to the flash memory, for collecting and temporarily storing a plurality of data into a cache line, and delivering them to the host simultaneously, so as to reduce data transmission time period.

Briefly summarized, the claimed invention provides a storage system of facilitating efficiency in accessing flash memory. The storage system comprises a flash memory, a cache unit, and a control unit. The flash memory comprises a plurality of blocks, each block having a plurality of pages, for storing data. The cache unit comprises a plurality of cache lines for storing data. The control unit, in response to a first read request to read a first read request data, is used for reading a first read request data from the plurality of cache lines if the first read request data held in the plurality of cache lines, and, in response to a second read request to read a second read request data, for storing the second read request data into the plurality of cache lines if the second read request data is not stored in the plurality of cache lines.

In addition, the storage system further comprises a host. The cache unit and the control unit are configured in the host. And the control unit is a software program stored in a memory of the host. The boundary of each cache line is 64K bytes or 128K bytes.

In one aspect of the present invention, in response to a third read request to read a third read request data, the control unit is used for writing the third read request data into a cache line which is to be read least times in the latest predetermined time period if the plurality of cache lines are filled.

According to the claimed invention, a method of facilitating efficiency in accessing a flash memory, the flash memory having a plurality of blocks, each block having a plurality of pages. The method comprises the steps of:
providing a cache unit comprising a plurality of cache lines;
in response to a first read request to read a first read request data, reading a first read request data from the plurality of cache lines if the first read request data held in the plurality of cache lines; and
in response to a second read request to read a second read request data, storing the second read request data into the plurality of cache lines if the second read request data is not stored in the plurality of cache lines.

In one aspect of the present invention, the claimed invention further comprises the step of: in response to a third read request to read a third read request data, writing the third read request data into a cache line which is to be read least times in the latest predetermined time period if the plurality of cache lines are filled.

In another aspect of the present invention, the claimed invention further comprises the step of: in response to a fourth read request to read a fourth read request data, dividing the fourth read request into a plurality of fifth requests, if length of the fourth read request exceeds the boundary of each cache line, wherein each size of which is limited to the boundary of the cache line.

According to the claimed invention, a storage system of facilitating efficiency in accessing flash memory comprises a flash memory, a cache unit, and a control unit. The flash memory comprises a plurality of blocks, each block having a plurality of pages, for storing data. The cache unit comprises a plurality of cache lines, for storing data to be written into the flash memory. The control unit, in response to a first write request to write a first write request data into the flash memory, is used for storing the first write request data into one of the plurality of cache lines, and for writing the first write request data stored in the cache line into the flash memory, if all of the plurality of cache lines are filled.

In addition, the storage system further comprises a host. The cache unit and the control unit are configured in the host. And the control unit is a software program stored in a memory of the host. The boundary of each cache line is 64K bytes or 128K bytes.

In one aspect of the present invention, the control unit is further used for writing the first write request data into the flash memory, if length of the first write request data exceeds the boundary of each cache line and the first write request data is not held in the plurality of cache lines.

In another aspect of the present invention, the control unit is further used for writing data in the cache unit into the flash memory, if an idle time period of the cache unit is over a predetermined time.

According to the claimed invention, a method of facilitating efficiency in accessing a flash memory is provided. The flash memory has a plurality of blocks, each block having a plurality of pages. The method comprises the steps of:
providing a cache unit comprising a plurality of cache lines;
in response to a first write request to write a first write request data into the flash memory, storing the first write request data into one of the plurality of cache lines; and
writing the first write request data stored in the cache line into the flash memory, if all of the plurality of cache lines are filled.

In one aspect of the present invention, the claimed invention further comprises the step of: writing the first write request data into the flash memory, if length of the first write request data exceeds the boundary of each cache line, and the first write request data is not held in the plurality of cache lines.

In another aspect of the present invention, the claimed invention further comprises the steps of: writing data in the cache unit into the flash memory, if an idle time period of the cache unit is over a predetermined time.

The present invention will be described with reference to the accompanying drawings, which show exemplary embodiments of the present invention.

### BRIEF DESCRIPTION OF THE DRAWINGS

FIG. 1 shows a structure of conventional NAND flash memory.

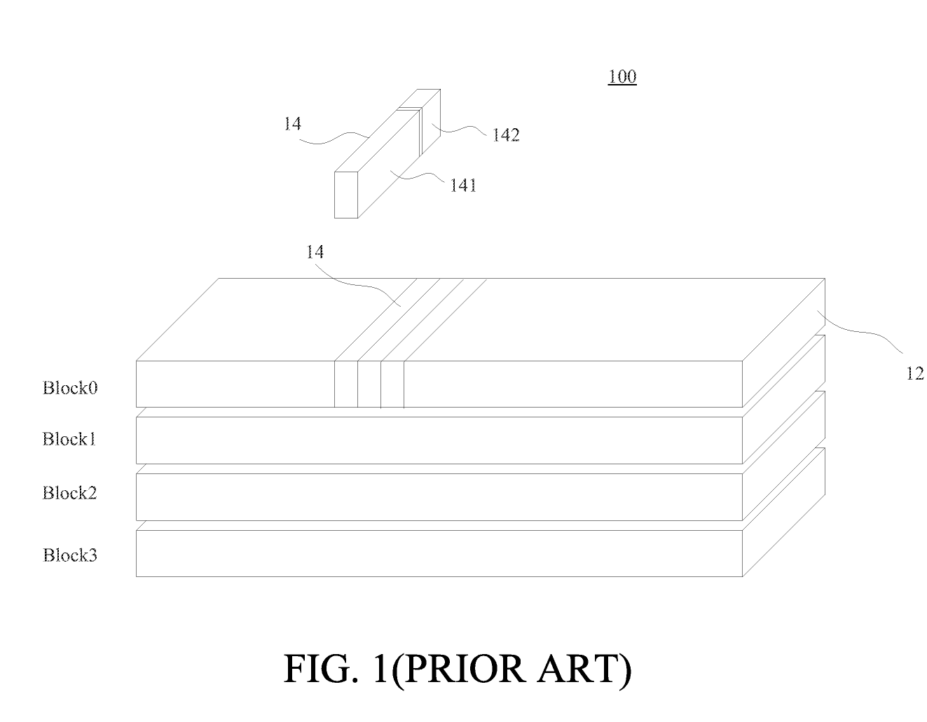

FIG. 2 shows an example of data translation between logical addresses and physical addresses.

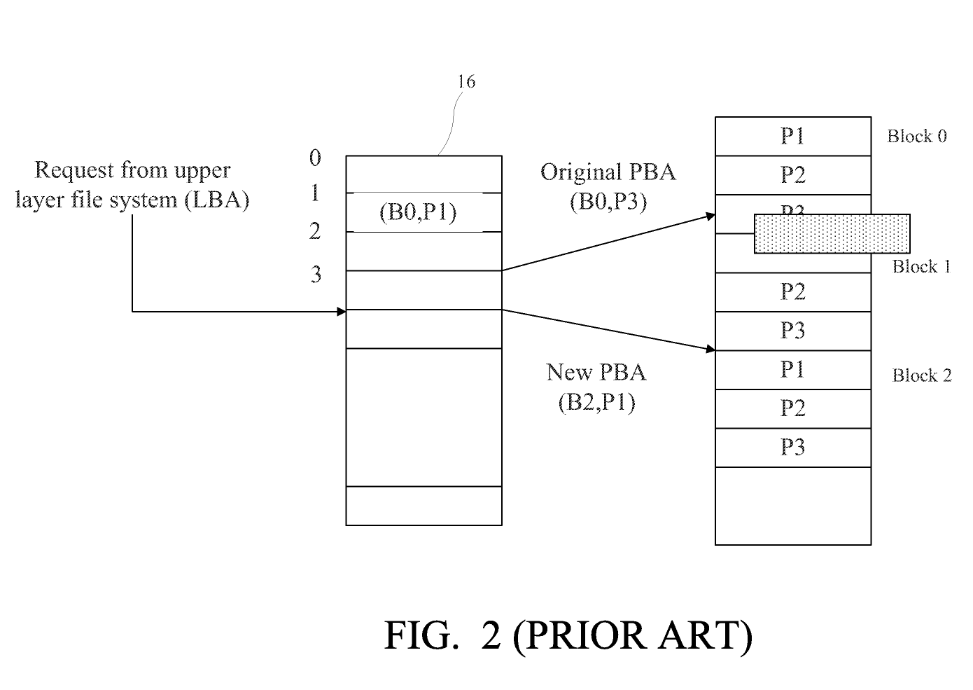

FIG. 3 illustrates a block diagram of a storage system according to a preferred embodiment of the present invention.

FIG. 4 illustrates a flash memory, a control unit, and a cache unit.

FIG. 5 is a flowchart of reading the flash memory from the host according to the present invention.

FIG. 6 is a flowchart of writing data from the host to the flash memory.

### DETAILED DESCRIPTION OF THE INVENTION

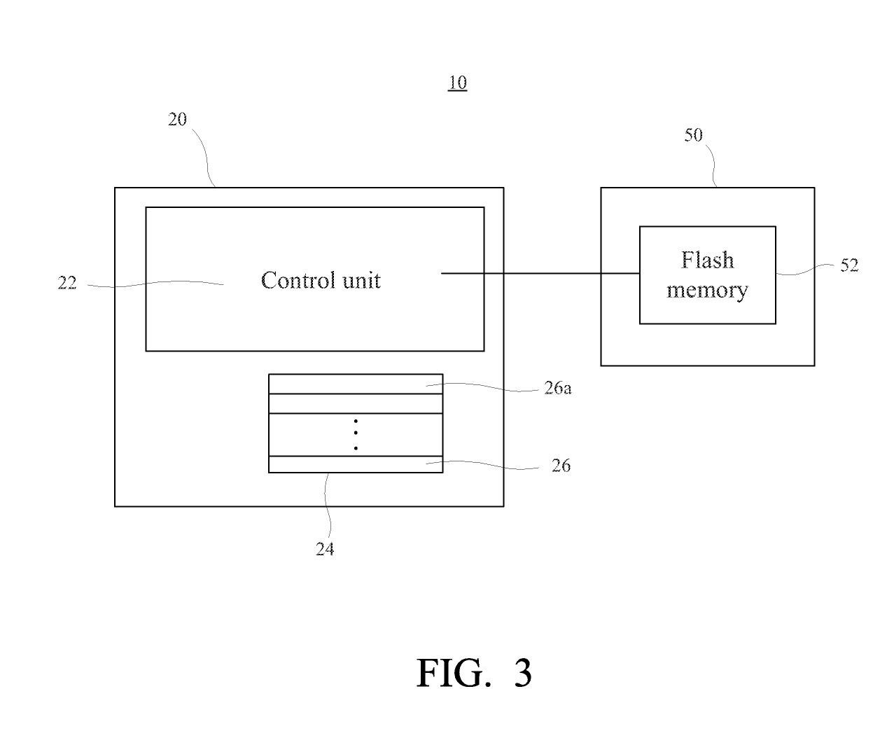

Referring to FIG. 3 illustrating a block diagram of a storage system 10 according to a preferred embodiment of the present invention, the storage system 10 comprises a host 20 and a flash memory storage device 50. The host 20 may be a desktop computer, a notebook computer or a recordable DVD player. The host 20 comprises a control unit 22 and a cache unit 24. The flash memory storage device 50 comprises a flash memory 52. In this embodiment, the flash memory 52 is divided as a plurality of blocks, and each block is composed of 64 pages, where each page may be 2K bytes or 512 bytes. The cache unit 24, implemented by a part of memory within the host 20, such as Dynamic Random Access Memory (DRAM), Static Random Access Memory (SRAM), is composed of a plurality of cache lines 26 with a capacity of, but not limit to, 128K bytes, 64K bytes or any capacity size relying on designers' demand. A relationship between each cache line capacity (C) and a block size (B) is shown as: C=B×2ⁿ, where n is an integer. The cache unit 24 controlled by the control unit 22 is used for temporarily storing data of the flash memory storage device 50 as cache data when the next read/write request is received. The control unit 22 is a software program embedded in a memory of the host 20, for intercommunicating the operating system and a storage device driver.

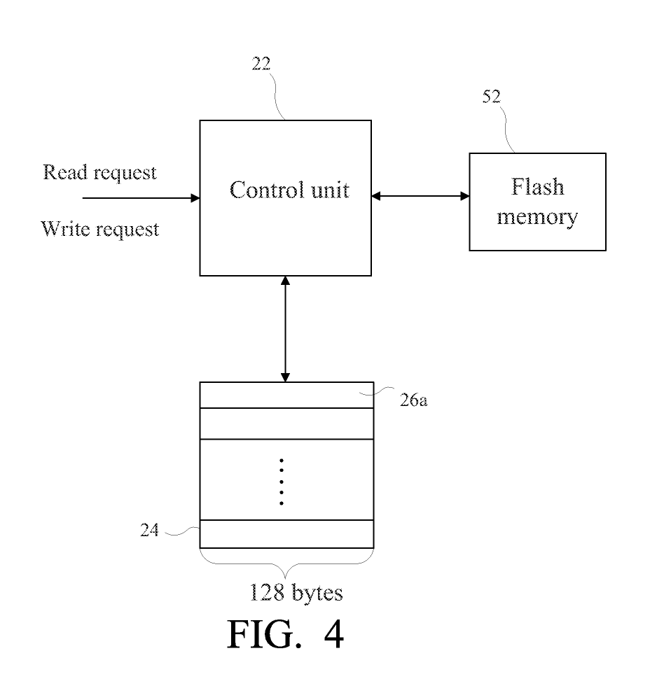

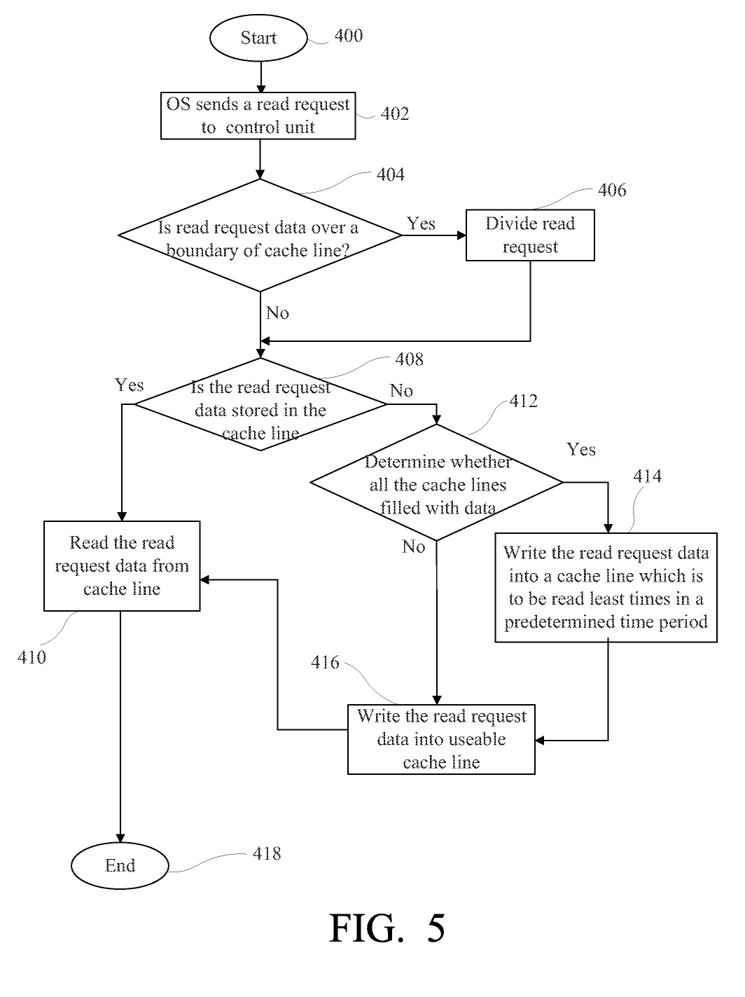

Please refer to FIGS. 4 and 5. FIG. 4 illustrates a flash memory 52, a control unit 22, and a cache unit 24. FIG. 5 is a flowchart of reading the flash memory from the host 20 according to the present invention. The reading process comprises the steps of:
Step 400: Start.
Step 402: Operating system sends a read request to a driving program within the control unit 24 so as to read the flash memory 52.
Step 404: Determine whether the read request data size is over a boundary of the cache line 26? If it is, go to Step 406, if not, go to Step 408.
Step 406: Divide the read request. If the addresses of the read request data is in excess of the boundary of the cache line, divide the read request into a plurality of new requests, each size of which is limited to the boundary of the cache line.
Step 408: Is the read request data stored in the cache line? If it is, go to Step 410; if not, go to Step 412.
Step 410: If the read request data is stored in the cache line, read it from the cache line.
Step 412: Determine whether all the cache lines filled with data. If it is, go to Step 414, if not, go to Step 416.
Step 414: If all the cache lines are filled with data, write the read request data from the flash memory into a cache line which is to be read least times in the latest predetermined time period, and then duplicate the read request data from the cache line to the target memory addresses assigned by the operating system. If the content of the target cache line is different with the content in the flash memory (referred to as a dirty cache), write back the cache line before read data into it.
Step 416: If part of cache lines are not stored data, write the read request data into usable cache line, and then duplicate the read request data from the cache line to the target memory addresses assigned by the operating system.
Step 418: End.

When the host 20 desires to read a first read request data of 24K bytes in the flash memory storage device 50, it delivers a first read request to the control unit 22. The first read request comprises Logical Block Address (LBA) and size of the first read request data. Then, the control unit 22 determines whether the size of the first read request data is over the boundary of the cache line 26 (Step 404). For example, if the boundary of the cache line 26 is 128K bytes, and a size of the first read request data is 256 bytes, the control unit 22 divides the first read request into two new read requests, both for requesting 128K bytes data (Step 406). Thereafter, the control unit 22 determines whether the first read request data is held in a cache line 26 of the cache unit 24 (Step 408). At this moment, the cache unit 24 is empty, so the control unit 22 determines the first request data is not held in the cache line 26. And then, the control unit 22 determines whether all cache line 26 are filled to confirm existence of any empty cache line 26. At this moment, all cache lines are empty, the control unit 22 selects one of the cache lines 26 to temporarily store the first read request data (Step 416). Subsequently, in response to a second read request to read a second read request data in the flash memory 52, the control unit 22 controls the second read request data stored in one of empty cache lines 26, if the second read request data is not yet stored in any cache line and some empty cache lines are available.

In response to a third read request to read a third read request data in the flash memory 52, if the third read request data has been stored in a cache line 26, the control unit 22 will directly fetch the third read request data from the cache unit (Step 410), instead of the flash memory 52. It is appreciated that if all cache lines are filled, the control unit 22, in response to a fourth request, examines read times of all the cache lines 26 and controls a dirty cache line which is to be read least times in the latest predetermined time period to temporarily store the fourth read request data. In addition, original data in the dirty cache line should be written back to the flash memory. Finally, the fourth read request data is duplicated from the cache line to the target memory addresses assigned by the operating system. By using the above mentioned read mechanism, as frequently reading a plurality of small data in the flash memory, the host 20 caches such small data in the cache unit without fetching data from the flash memory again and again, thereby shortening prepared time period of reading the plurality of small data. For example, using prior art technique, if the host sends a number of ten consecutive read requests, each of which is used for reading 2K bytes, to read 20K bytes data from the flash memory, each read request corresponds to a read procedure, as extends more prepared time period. Conversely, using the present invention, the 20K bytes data corresponding to ten read requests is collected and stored in the cache unit, and then is to be read in one time, the entire prepared time period is accordingly shortened.

It is appreciated that the control unit 22 will directly send read data which exceeds the maximum data readable in a session by the operating system to the flash memory 52 instead of cache unit 24.

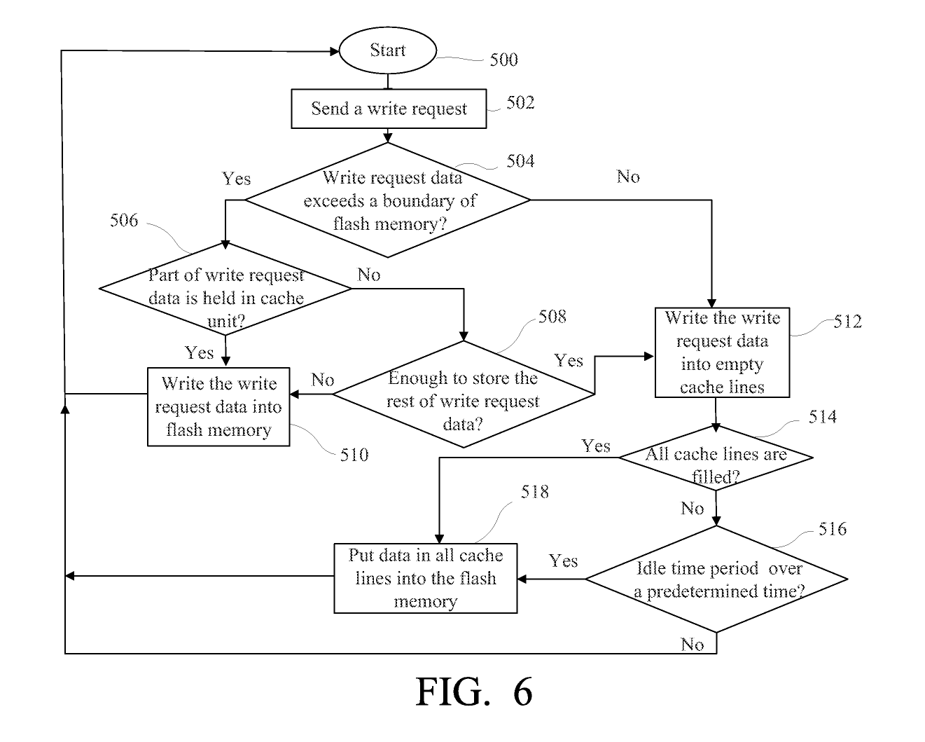

Please refer to FIGS. 4 and 6. FIG. 6 is a flowchart of writing data from the host 20 to the flash memory 52. The writing method occurs:
Step 500: Start.
Step 502: The host 20 sends a write request to the flash memory 52, so as to write data into the flash memory 52.
Step 504: Determine whether the write request data exceeds a boundary of the cache line. If it is, go to Step 506, if not, go to Step 512.
Step 506: If the write request data exceeds the boundary of the cache line, determine whether part of the write request data is held in the cache unit. If it is, go to Step 508, if not, go to Step 510.
Step 508: If part of the write request data is held in the cache unit, determine whether the empty cache lines is enough to store the rest of the write request data. If it is, go to Step 512, if not, go to 510.
Step 510: Write the part of write request data which does not contains in cache line into the flash memory. Write the other part of write request data into the cache line.
Step 512: Write the write request data into empty cache lines, if the write request data is less than the size of the cache line.
Step 514: Determine whether all cache lines are filled. If it is, go to Step 518, if not, go to Step 516.
Step 516: Determine whether an idle time period of the cache unit is over a predetermined time. If it is, go to 518, if not, go to Step 500.
Step 518: Put data in all cache lines into the flash memory, if all cache lines are filled or the cache unit is idle in excess of the predetermined time.

When the host 20 desires to write a first write request data of 24K bytes into the flash memory storage device 50, it delivers a first write request to the control unit 22 (Step 502). The first write request comprises Logical Block Address (LBA) and size of the first write request data. Then, the control unit 22 determines whether the size of the first write request data is over the boundary of the cache line 26 (Step 504). For example, if the boundary of the cache line 26 is 128K bytes, and a size of the first write request data is 24K bytes, the control unit 22 controls the cache line 26a to temporarily store the first write request data (Step 512). Thereafter, in response to a second write request to write a second request data of 10K bytes, the control unit 22 controls the second write request data in one of the cache line 26, e.g. cache line 26a, if the size of the first write request data is less than the boundary of the cache line 26. At this moment, the first and second write request data are stored in the cache line 26a. Afterwards, on receiving a third write request data to write a third write data of 256K bytes which is cross the boundary of the cache line 26, the control unit 22 examines whether part of the third write request data has been stored in the cache line 26a, i.e. examines whether part of the third write request data shares with the first write request data present in the cache line 26a. If the third write request data is not shared with the first write request data, the third write request data is directly written into the flash memory 52. On the contrary, if part of the third write request data is shared with the first write request data, the control unit 22 detects whether empty cache lines 26 are enough to store all the third write request data. If empty cache lines 26 are enough to store all the third write request data, the third write request data is directly written into the cache unit 24; otherwise, the third write request data is directly written into the flash memory 52.

After the write request data is written into the cache unit 24, the control unit22 examines whether all cache lines 26 are filled, i.e. the cache unit 24 is filled (Step 514). If all cache lines 26 are filled, the control unit 22 removes data within cache unit 24 to the flash memory 52. In addition, in case that the cache unit 24 is idle in excess of a predetermined time period (Step 516), the control unit 22 also removes data within cache unit 24 to the flash memory 52.

In sum, through above-mentioned write mechanism, the control unit 22 temporarily stores a plurality of small write request data into the cache unit. When all cache unit 24 is filled or cache unit 24 is idle in excess of a predetermined time period, the control unit 22 removes data within cache unit 24 to the flash memory 52. Therefore, as consecutively receiving a plurality of write requests, with prior art technique, it must immediately write data into the flash memory in response to a write request. Nevertheless, the present invention collects data into a cache unit, and removes the collected data to the flash memory upon the cache unit is filled or an idle time period of the cache unit in excess of a predetermined time. For example, using prior art technique, if the upper layer file system in the host sends a number of ten consecutive write requests, each of which is used for writing 2K bytes, to write 20K bytes data to a block of the flash memory, the block will be erased and overwritten by 10 times. Conversely, using the present invention, the ten consecutive write request data corresponding to ten respective read requests are collected and stored in the cache unit, and then is to be written to the block in one time. In doing so, the block is erased and overwritten by one time, thereby shortening the entire write time period.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A storage system of facilitating efficiency in accessing flash memory, comprising:
a flash memory comprising a plurality of blocks, each block having a plurality of pages, for storing data;
a cache unit comprising a plurality of cache lines, for storing data; and
a control unit, in response to a first read request to read a first read request data, for reading a first read request data from the plurality of cache lines if the first read request data held in the plurality of cache lines, and, in response to a second read request to read a second read request data, for storing the second read request data into the plurality of cache lines if the second read request data is not stored in the plurality of cache lines.

2. The storage system of claim 1 further comprising a host, wherein the cache unit and the control unit are configured in the host.

3. The storage system of claim 2, wherein the control unit is a software program stored in a memory of the host.

4. The storage system of claim 1, wherein in response to a third read request to read a third read request data, the control unit is used for writing the third read request data into a dirty cache line which is to be read least times in the latest predetermined time period if the plurality of cache lines are filled, and writing data in the dirty cache line back to the flash memory before writing data into the cache line.

5. The storage system of claim 1, wherein a boundary of each cache line is 64K bytes or 128K bytes.

6. A method of facilitating efficiency in accessing a flash memory, the flash memory having a plurality of blocks, each block having a plurality of pages, the method comprising:
providing a cache unit comprising a plurality of cache lines;
in response to a first read request to read a first read request data, reading a first read request data from the plurality of cache lines if the first read request data held in the plurality of cache lines; and
in response to a second read request to read a second read request data, storing the second read request data into the plurality of cache lines if the second read request data is not stored in the plurality of cache lines.

7. The method of claim 6, further comprising:
in response to a third read request to read a third read request data, writing the third read request data into a dirty cache line which is to be read least times in the latest predetermined time period if the plurality of cache lines are filled, and writing data in the dirty cache line back to the flash memory.
Write back data from the dirty cache before read data into it.

8. The method of claim 6, further comprising:
in response to a fourth read request to read a fourth read request data, dividing the fourth read request into a plurality of fifth requests, if length of the fourth read request exceeds the boundary of each cache line, wherein each size of which is limited to the boundary of the cache line.

9. A storage system of facilitating efficiency in accessing flash memory, comprising:
a flash memory comprising a plurality of blocks, each block having a plurality of pages, for storing data;
a cache unit comprising a plurality of cache lines, for storing data to be written into the flash memory;
a control unit, in response to a first write request to write a first write request data into the flash memory, for storing the first write request data into one of the plurality of cache lines, and for writing the first write request data stored in the cache line into the flash memory, if all of the plurality of cache lines are filled.

10. The storage system of claim 9, wherein the control unit is further used for writing the first write request data into the flash memory, if length of the first write request data exceeds the boundary of each cache line and the first write request data is not held in the plurality of cache lines.

11. The storage system of claim 9, wherein the control unit is further used for writing data in the cache unit into the flash memory, if an idle time period of the cache unit is over a predetermined time.

12. The storage system of claim 9, further comprising a host, wherein the cache unit and the control unit are configured in the host.

13. The storage system of claim 12, wherein the control unit is a software program stored in a memory of the host.

14. The storage system of claim 9, wherein a boundary of each cache line is 64K bytes or 128K bytes.

15. A method of facilitating efficiency in accessing a flash memory, the flash memory having a plurality of blocks, each block having a plurality of pages, the method comprising:
providing a cache unit comprising a plurality of cache lines;
in response to a first write request to write a first write request data into the flash memory, storing the first write request data into one of the plurality of cache lines; and
writing the first write request data stored in the cache line into the flash memory, if all of the plurality of cache lines are filled.

16. The method of claim 15, further comprising:
writing the first read request data into the flash memory, if length of the first write request data exceeds the boundary of each cache line and the first write request data is not held in the plurality of cache lines.

17. The method of claim 15, further comprising:
writing data in the cache unit into the flash memory, if an idle time period of the cache unit is over a predetermined time.
